(19) United States
(12) Patent Application Publication
(10) Pub. No.: US 2015/0277683 A1
(43) Pub. Date: Oct. 1, 2015

(54) ADAPTIVE USER EXPERIENCE

(71) Applicant: Foneclay Inc., RSF, CA (US)

(72) Inventors: Isaac Eshagh Eteminan, Rancho Santa Fe, CA (US); James William Bishop, JR., Colorado Springs, CO (US)

(21) Appl. No.: 14/461,279

(22) Filed: Aug. 15, 2014

Related U.S. Application Data
(60) Provisional application No. 61/971,693, filed on Mar. 28, 2014.
(60) Provisional application No. 61/981,989, filed on Apr. 21, 2014.

(51) Int. Cl. G06F 3/0484; H04L 29/08; G06F 17/30

(52) U.S. Cl. CPC G06F 3/0484; G06F 17/30876; H04L 67/306

(57) ABSTRACT

An automated method adapted to provide an adaptive user experience is described. The method includes: determining that a user device is within a defined region; receiving a set of user experience elements associated with the defined region; generating an adaptive user interface (UI) that includes at least a sub-set of the user experience elements; and providing the adaptive UI via at least one output element of the user device. A second automated method adapted to provide an adaptive user experience via a user device includes: determining whether a subscriber interface module (SIM) is connected to the user device; reading data from the SIM; retrieving user information associated with the SIM; and presenting a user interface based at least partly on the retrieved user information.

### CROSS-REFERENCE TO RELATED APPLICATIONS

This application claims priority to U.S. Provisional Patent Application Ser. No. 61/971,693, filed on Mar. 28, 2014 and U.S. Provisional Patent Application Ser. No. 61/981,989, filed on Apr. 21, 2014.

### BACKGROUND OF THE INVENTION

Mobile devices (e.g., smartphones, tablets, notebook computers, etc.) are ubiquitous in society. Many users of such devices may shop, either online or in person, for various items. Such users may frequent certain physical establishments based on various factors associated with each user (e.g., location, type of establishment, etc.).

While shopping in an establishment, a user may desire specific information related to an establishment (e.g., available products, prices, specials, etc.), user preferences, and/or historical information. The specific information may not be available and/or may be made available in disperse environments such that a user is not able to acquire and/or evaluate relevant information in a timely, efficient manner.

In addition, each establishment may wish to provide a customized experience to each user related to user preferences and/or habits, and/or other relevant criteria (e.g., by providing data based on demographic data associated with a user, by providing data based on a specific user environment, etc.).

Therefore there exists a need for a way to automatically provide a customized shopping experience based on establishment preferences, user preferences, user environment, and/or other relevant factors.

### BRIEF SUMMARY OF THE INVENTION

Some embodiments provide a way to generate and selectively provide a native user experience and an adaptive user experience based on various relevant factors. Such factors may include, for instance, a user's location and/or association with a particular establishment, user preferences, third party preferences, device capabilities, user identification, mood, intent, activity, and/or other relevant factors.

The adaptive user experience may include elements provided by various user device features. Such features may include, for example, displays and speakers. In some embodiments, the adaptive user experience may include elements that are pushed to various device screens or other outputs (e.g., a lock screen, and/or multiple pages or sheets of screens that may be available when using a user device such as a smartphone or tablet). The content of any or all such pages or screens may be at least partly based at least partly on the factors identified above.

Various resources may be provided via the adaptive experience. For instance, a user may perform a third-party search via the adaptive experience. Such resources may be optimized based on the relevant factors listed above.

The adaptive user experience may be continuously updated based on detected environmental elements. For instance, audio or graphic data may be received via an appropriate user device element such as a microphone or camera. Such data may be analyzed to determine various relevant factors such as a user's location, mood, identity, association with an establishment, and/or other relevant factors.

Some embodiments may collect analytic data based on the adaptive user experience. Such data may include time spent associated with an establishment, search queries, etc. The analytic data may be provided to various parties (e.g., retail businesses associated with one or more establishments) and/or used to modify the adaptive user experience.

A first exemplary embodiment of the invention provides an automated method adapted to provide an adaptive user experience. The method includes: determining that a user device is within a defined region; receiving a set of user experience elements associated with the defined region; generating an adaptive user interface (UI) that includes at least a sub-set of the user experience elements; and providing the adaptive UI via at least one output element of the user device.

A second exemplary embodiment of the invention provides an automated method adapted to provide an adaptive user experience via a user device. The method includes: determining whether a subscriber interface module (SIM) is connected to the user device; reading data from the SIM; retrieving user information associated with the SIM; and presenting a user interface based at least partly on the retrieved user information.

A third exemplary embodiment of the invention provides a user device including: a communications module adapted to communicate with external devices using at least one wireless communication pathway; a set of software interfaces adapted to allow interaction with a set of software components of the user device; a set of hardware interfaces adapted to allow interaction with a set of hardware elements of the user device; and a set of user interface (UI) modules adapted to generate UI elements to be presented via at least one hardware element from the set of hardware elements.

A fourth exemplary embodiment of the invention provides a system adapted to generate and provide an adaptive user experience. The system includes a server; a user device; and a third-party device. The server includes: a storage interface; a dashboard; a control module; a communications module; and a server-side application. The user device includes: a client-side application; a communications module; a set of software interfaces; a set of hardware interfaces; and a user interface (UI) module. The third party device includes: a browser; a storage interface; and a third-party application.

A fifth exemplary embodiment of the invention provides an automated method adapted to provide an adaptive user experience. The method includes: providing a first user experience; detecting and identifying a set of environmental elements; determining whether some update criteria have been met based at least partly on the set of environmental elements; and generating and providing a second user experience when the update criteria have been met and providing the first user experience when the update criteria have not been met.

The preceding Brief Summary is intended to serve as a brief introduction to various features of some exemplary embodiments of the invention. Other embodiments may be implemented in other specific forms without departing from the spirit of the invention.

### BRIEF DESCRIPTION OF THE SEVERAL VIEWS OF THE DRAWINGS

The novel features of the invention are set forth in the appended claims. However, for purpose of explanation, several embodiments of the invention are illustrated in the following drawings.

FIG. 1 illustrates a schematic block diagram of a conceptual hardware system according to an exemplary embodiment of the invention;

FIG. 2 illustrates a schematic block diagram of a conceptual establishment system according to an exemplary embodiment of the invention;

FIG. 3 illustrates a schematic block diagram of a conceptual software system according to an exemplary embodiment of the invention;

FIG. 4 illustrates a message flow diagram of a communication scheme used by some embodiments of the systems of FIGS. 1 and 3 to provide an adaptive user experience;

FIG. 5 illustrates a flow chart of a conceptual process used by some embodiments to provide an adaptive user experience;

FIG. 6 illustrates a flow chart of a conceptual process used by some embodiments to provide an adaptive user experience based on an association with an establishment;

FIG. 7 illustrates a flow chart of a conceptual process used by some embodiments to update data associated with the adaptive user experience;

FIG. 8 illustrates a flow chart of a conceptual process used by some embodiments to provide relevant information within the adaptive user experience based on a query;

FIG. 9 illustrates a flow chart of a conceptual process used by some embodiments to provide a real-time adaptive user experience;

FIG. 10 illustrates a flow chart of a conceptual process used by some embodiments to update a user experience based on a subscriber identification module (SIM);

FIG. 11 illustrates a flow chart of a conceptual process used by some embodiments to update a user experience based on relevant analytic data; and

FIG. 12 illustrates a schematic block diagram of a conceptual computer system used to implement some embodiments of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, as the scope of the invention is best defined by the appended claims.

Various inventive features are described below that can each be used independently of one another or in combination with other features. Broadly, some embodiments of the present invention provide a way to generate a user experience that is adapted to a specific establishment (and/or sub-establishment), a specific user, and/or other relevant factors. Some embodiments may provide a full launcher used to at least partially control operation of a user device.

Several more detailed embodiments of the invention are described in the sections below. Section I provides a conceptual description of various hardware elements used by some embodiments. Section II then describes various software elements used by some embodiments. Next, Section III describes various methods of operation used by some embodiments. Lastly, Section IV describes a computer system which implements some of the embodiments of the invention.

### I. Hardware Systems

Sub-section I.A provides a conceptual description of distributed system of some embodiments. Sub-section I.B then describes a localized system of some embodiments.

### A. Distributed System

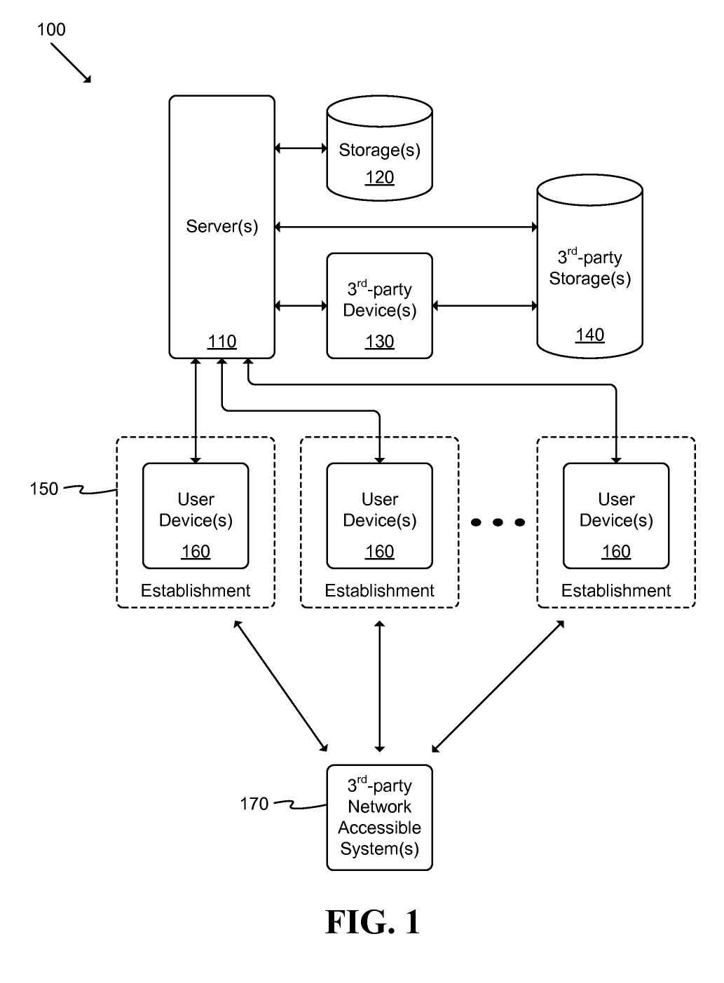

FIG. 1 illustrates a schematic block diagram of a conceptual hardware system 100 according to an exemplary embodiment of the invention. As shown, the system may include a set of servers 110 with associated storages 120, 3^{rd} party devices 130 with associated storages 140, one or more establishments 150, multiple user devices 160, and a set of network accessible systems 170.

In this example, each user device 160 is associated with an establishment 150. Throughout this disclosure, the term “establishment” may be used to refer to various physical structures and/or regions (e.g., a retail store, a mall, a restaurant, a museum, a theme park, etc.) and/or sub-regions thereof (e.g., sections of a retail store or restaurant, theme park attractions, museum exhibits, etc.), among other potential locations, regions, and/or otherwise defined areas or establishments that may be associated with an adaptive user experience. In addition, an “establishment” may refer to a set of associated structures and/or regions (e.g., a major retailer with multiple store locations, a group of otherwise independent retailers collaborating on a customer incentive program, etc.).

An establishment may also refer to a brand or product. In such cases, a user experience associated with the brand or product may be presented to a user when the user enters one of multiple defined regions associated with the brand or product (e.g., a cosmetic line that is carried in several retailers). Such establishments may also include multiple brands and/or products.

A user device 160 may be associated with an establishment if the user device location is within a defined region associated with the establishment (and/or based on other appropriate sets of criteria).

Throughout this disclosure, the term “user” may be used to refer to a consumer-user (i.e., a retail shopper), a 3^{rd} party user (e.g., an employee user associated with an establishment). The adaptive user experience of some embodiments may typically be presented to a consumer-user via a user device associated with that user. A 3^{rd} party user may access the system via a different interface (e.g., a dashboard).

Any type of user may have an “account” associated with the system access provided to the user. Each account may include various identifying information elements (e.g., login id, password, etc.). Such accounts may be used to determine the type of access granted to the user and/or other parameters associated with the user.

Some embodiments may use geo-fence notifications to determine when the user device is within the defined region. Other embodiments may determine device location in various other appropriate ways (e.g., using global positioning system (GPS) signals, using cell tower signal strength triangulation, using wireless network access information, etc.). Alternatively, a user may make a selection or otherwise indicate that the user device is within the defined region (e.g., by scanning a matrix barcode or other visual information element that is associated with the region). In some embodiments, audio and/or video sensors in the user device may detect that media associated with an establishment is playing in the vicinity and thereby determine that the user device is within an appropriate region; such media may include, for instance, movies, videos, images, music, sub-audible tone sequences, subliminal flashes of light, and/or other appropriate elements that are able to be perceived by the user device.

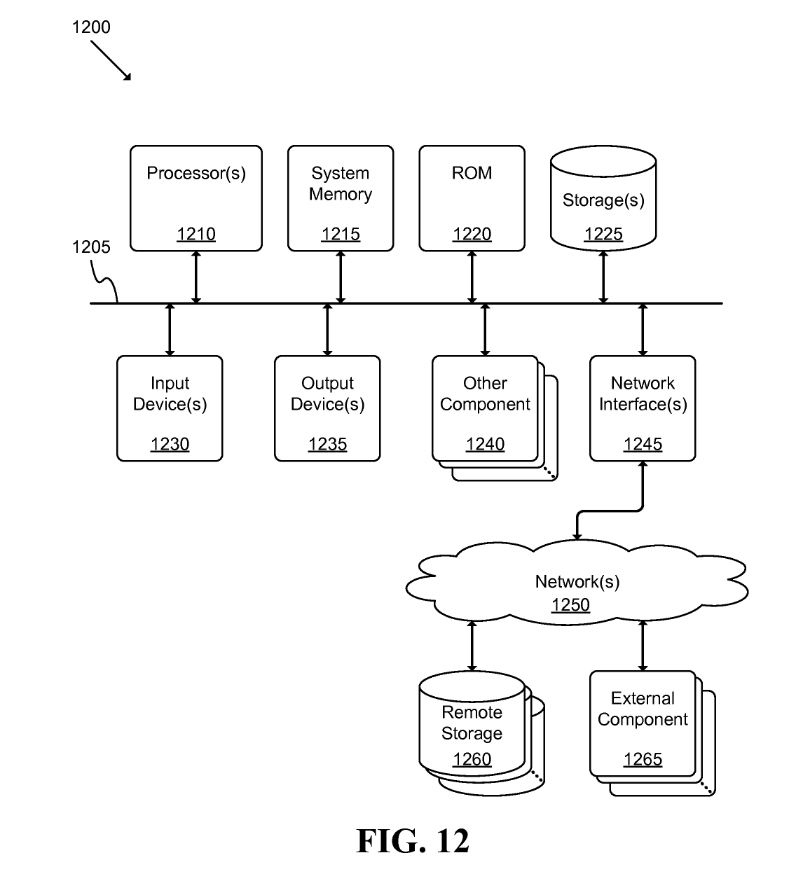

The set of servers 110 may include at least one device that is capable of executing instructions, processing data, and/or communicating across one or more networks. The associated storage(s) 120 may include one or more devices capable of storing data and/or instructions. Such devices will be described in more detail in reference to FIG. 12 below.

Each 3^{rd} party device 130 may be any device that is capable of executing instructions, processing data, and/or communicating across one or more networks. The associated 3^{rd} party storage(s) 140 may include one or more devices capable of storing data and/or instructions. Such devices will be described in more detail in reference to FIG. 12 below. The 3^{rd} party devices 130 may be associated with one or more establishments 150.

The servers 110 may be able to access the associated storages 120 and/or 3^{rd} party storages 140 in various appropriate ways. For instance, the storages 120 may be directly connected to the servers 110. Alternatively, the storages 120 and 140 may be accessed using one or more networks. In addition, the storages may be accessed using one or more application programming interfaces (APIs).

Each user device 160 may be a mobile device such as a smartphone, tablet, etc. The user devices may be able to communicate with the servers 110 via one or more networks (e.g., local area networks, cellular networks, wireless networks, etc.). In addition, the user devices 160 may be able to access various 3^{rd} party devices 130 and/or storages 140 via the servers. Furthermore, the user devices may be able to access various 3^{rd} party network accessible systems 170 via one or more networks without involving the servers 110.

The 3^{rd} party network accessible systems 170 may include systems associated with GPS data, systems associated with establishments, etc.

One of ordinary skill in the art will recognize that system 100 is conceptual in nature and may be implemented in various specific ways without departing from the spirit of the invention. For instance, different embodiments may include different specific components and/or communication pathways among the various components.

### B. Local System

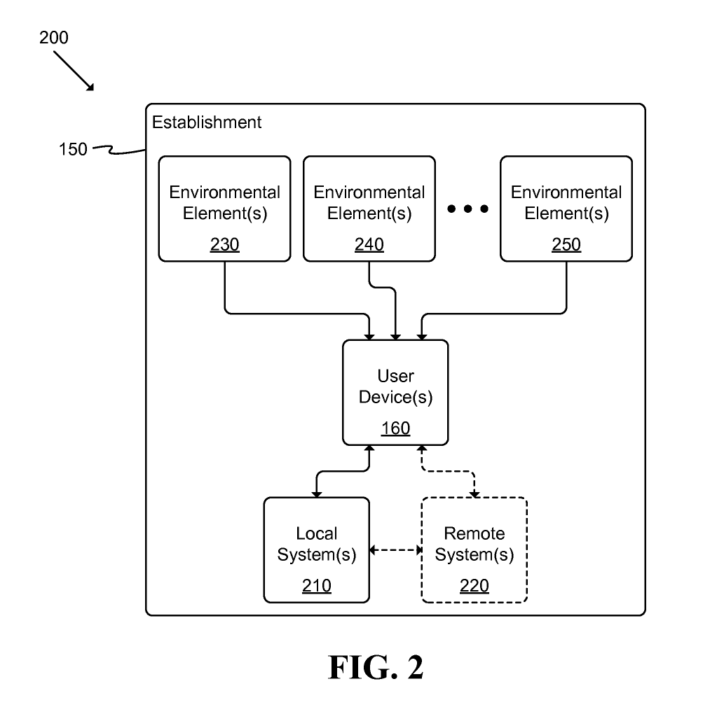

FIG. 2 illustrates a schematic block diagram of a conceptual establishment system 200 according to an exemplary embodiment of the invention. As shown, the system may include an establishment 150 and user device(s) 160 described above. In addition, the system 200 may include local systems 210, remote systems 220, and various environmental elements 230-250.

Each local system 210 may include access elements (e.g., devices used to provide wireless network access), storages, and/or other appropriate elements (e.g., local servers or clients that may be accessed by the user devices 160). In addition, the local system 210 and/or elements thereof may be used to allow a user device to connect to various remote systems 220. Alternatively, the user devices 160 may be able to access the remote systems via external resources (e.g., a cellular communication network, a wireless network that serves multiple establishments, etc.).

Each remote system 220 may include elements similar to those described above in reference to FIG. 1. The availability of remote systems 220 may be based at least partly on the user device 160, an associated user, access path, and/or other relevant factors. For instance, a customer may access a first interface related to the establishment while an employee may access a different interface related to the establishment.

The environmental elements 230-250 may include items such as media (e.g., a user device microphone may detect audio or video information that may be associated with one or more brands, manufacturers, items, etc.), video or graphical information (e.g., a matrix bar code, a poster featuring a product or other item, a movie playing on a nearby device, etc.), and/or other environmental elements that may be detected by the user device 160 (e.g., ambient light levels, ambient noise levels, relative position of a user, etc.).

The environmental elements 230-250 may allow the user device to adapt the user experience based on data associated with the environmental elements. For instance, a recording artist that is being played on a sound system associated with the establishment 150 may be associated with a special offer related to the artist for any items that are sold at the establishment.

One of ordinary skill in the art will recognize that system 200 is conceptual in nature and may be implemented in various specific ways without departing from the spirit of the invention. For instance, different embodiments may include different specific components and/or communication pathways among the various components.

Some embodiments may include elements from system 100 and 200. For instance, a single distributed system 100 may be associated with various establishments, where at least one of the establishments is associated with a local system 200.

### II. Software Systems

Sub-section II.A provides a conceptual description of a distributed software system of some embodiments. Sub-section II.B then describes a communication protocol of some embodiments.

The software systems described below may be implemented using systems such as those described above in reference to FIGS. 1-2. In addition, as described above and in reference to FIG. 12 below, different embodiments may be implemented using various different combinations of software elements and/or hardware elements. Thus, although some elements may be described by reference to software features, one of ordinary skill in the art will recognize that such elements may be able to be implemented using various combinations of electronic circuitry that is able to operate without requiring execution of any code or instructions.

### A. Distributed System

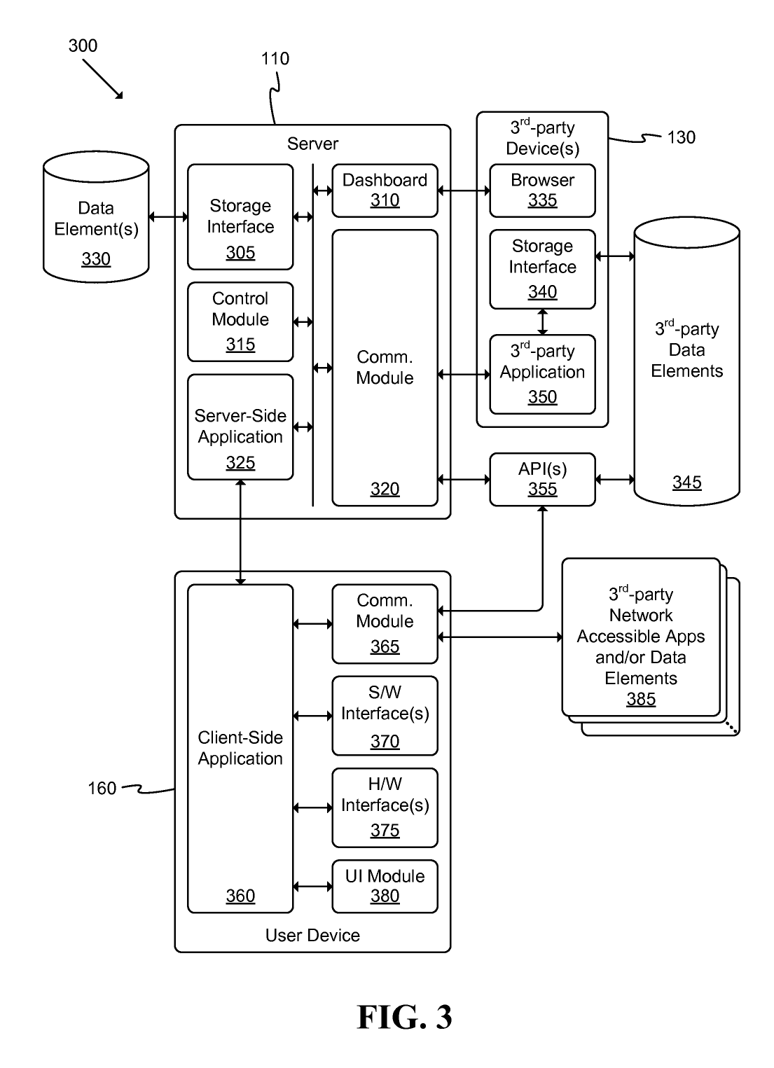

FIG. 3 illustrates a schematic block diagram of a conceptual software system 300 according to an exemplary embodiment of the invention. As shown, the system may include a server 110 with a storage interface 305, dashboard 310, control module 315, communication module 320, server-side application 325, and a set of data elements 330. The system may also include one or more 3^{rd} party devices 130, each having a browser 335, storage interface 340, a set of data elements 345, and one or more 3^{rd} party applications 350. Some embodiments may include one or more APIs 355 that may be accessible to various system elements and/or provide access to other system elements. The system may further include a user device 160 with a client-side application 360, communication module 365, software interfaces 370, hardware interfaces 375, and a user interface (UI) module 380. In addition, the system may include a set of 3^{rd} party network accessible applications and/or data elements 385.

The storage interface 305 may allow the server to access various data elements 330 or storages (e.g., storage 120). Such data elements 330 may be accessed using one or more networks.

The data elements may include information related to the establishments (e.g., graphics, product information, etc.), information related to user behavior (e.g., analytic data collected from one or more users), data that may control the operation of various server components, and/or other relevant data.

The dashboard 310 may allow a 3^{rd} party to access the server using a 3^{rd} party device 130. Such a dashboard 310 may be presented in various appropriate ways (e.g., via a web browser, via a dedicated application, etc.). The dashboard may allow a 3^{rd}-party user such as an establishment employee to update information associated with the establishment. Such information may include, for instance, data related to product availability, product location, prices, sale items, specials, etc.

The control module 315 may control the operations of the server 110, including the operations of various other server components, and may be able to communicate among the various other server components.

The communications module 320 may allow the server 110 to communicate among various external resources (e.g., 3^{rd}-party devices, web-based resources, etc.). The communications module 320 may be able to communicate across one or more networks (e.g., wireless networks, cellular networks, the Internet, etc.) and/or access one or more APIs (e.g., API 355).

The server-side application 325 may communicate with the client-side application 360 (e.g., via one or more network connections such as wireless networks, cellular networks, the Internet, etc.). The server-side application 325 may be adapted to send and/or receive messages, instructions, analytics, and/or other data to and/or from the client-side application 360. The server-side application 325 may be adapted to interact with multiple client-side applications 360 associated with multiple user devices 160.

The “browser” 335 (which may include various web browsers, dedicated applications, device resources, etc.), may allow a 3^{rd} party user (e.g., a representative of an establishment) to access the server dashboard 310 in order to manipulate data and/or operations associated with the 3^{rd} party. For instance, a store manager may access the dashboard to update weekly price lists. As another example, a regional manager may access the dashboard to update promotion graphics for a set of establishments within the region.

The storage interface 340 may allow the 3^{rd} party device 130 to access various data elements 345 or storages. Such data elements may be accessed across one or more networks. The data elements may include information related to the establishments, data that may control the operation of various 3^{rd} party components, etc.

The 3^{rd} party application 350 may allow each 3^{rd} party device to communicate with the communication module 320 of the server 110. Such a communication pathway may, for instance, allow the server to retrieve data or instructions via the 3^{rd} party device 130 (e.g., data related to an establishment or location such as product data, price information, etc.).

Each API 355 may allow the server 110 and/or user device 130 to access various external data elements. The API(s) 355 may be provided by external resources (e.g., 3^{rd} party servers) that are accessible across one or more networks. Such APIs may also be accessible to the 3^{rd} party devices (e.g., web-accessible APIs).

The client-side application 360 may communicate with the server-side application 325 (e.g., via one or more network connections such as wireless networks, cellular networks, the Internet, etc.). The client-side application 360 may be adapted to send and/or receive messages, instructions, analytics, and/or other data to and/or from the server-side application 325.

The communications module 365 may allow the user device 160 to communicate among various external resources (e.g., 3^{rd}-party network accessible resources, web-based resources, etc.). The communications module 365 may be able to communicate across one or more networks (e.g., wireless networks, cellular networks, the Internet, etc.) and/or access one or more APIs 355.

The software interface(s) 370 and hardware interface(s) 375 may allow the client-side application 360 to interact with and/or control functionality and/or resources provided by the user device 160 (e.g., input/output devices such as keypads, touchscreens, etc., local storages, audio/video components, cameras, movement, vibration, location services, and network connectivity, among others).

The interfaces 370-375 may include (and/or be able to access) various processing modules (e.g., an audio analysis processor, a video analysis processor, a geolocation processor, etc.). Such processing modules may be able to evaluate information received via the interfaces (e.g., position information, audio information, photographic information, etc.) from various elements of the user device (e.g., GPS sensors, microphones, cameras, etc.) in order to identify elements within the received information (e.g., graphical elements, audio elements, position elements, etc.) that may be associated with the adaptive user experience. In some embodiments, such processing modules may operate cooperatively to detect various relevant conditions (e.g., location, user identity, activity, intent, mood, etc.).

The UI module 380 may be adapted to generate various UI elements (e.g., graphics, physical buttons, touchscreen elements, etc.) and present them to the user. In addition, the UI module may be adapted to receive information related to various user actions (e.g., touchscreen commands, phone movements, etc.) and use the received information to at least partially control various operations of the client-side application 360.

The 3^{rd} party network accessible applications and/or data elements 385 (and/or other appropriate resources) may be accessed by the user device 160 directly (or via one or more networks) without requiring connection to a server 110. Such 3^{rd} party resources 385 may include, for instance, location resources that may be used to determine when a user device 160 is within a defined region. In addition, in some embodiments, the server-side application 325 (via the client-side application 360) may control the operations of the user device 160 such that data and/or instructions are retrieved by the user device from a 3^{rd} party resource 385.

In some embodiments, the client-side application 360 may be included with the various other modules 365-380 (and/or other appropriate modules) in a single executable entity. Thus, the term “client-side application” may refer to the collection of elements or modules provided by the user device 160 according to some embodiments.

In some embodiments, the client-side application 360 (and/or associated elements) may be executed as a background application when a user device 160 is functioning in a “native” mode. Native mode may include presentation of various user interfaces (e.g., sets of application icons arranged on one or more home pages) as the device may normally operate without any adaptive location-based user experience elements provided by some embodiments.

The client-side application 360 may be activated based on various appropriate sets of criteria (e.g., by receiving a notification from the server-side application 325, by determining that the user device 160 is within a defined region, when a bar matrix code or other environmental element is detected, etc.).

When the client-side application 360 is activated, the user device 160 display (and/or other UI elements) may be updated to include information related to the establishment. For instance, various user “home” screens may be manipulated such that various user experience elements are presented on the different screens (e.g., deal of the day, clearance items, shopping list generation based on analytic data, product search, coupons, etc.). The content of such items may be based at least partly on data provided by a 3^{rd} party user associated with the establishment. Such content may be presented to the user using various appropriate user device features (e.g., “push” messages, display updates, etc.).

Furthermore, native elements of the user device interface associated with typical or normal functions (e.g., placing a phone call, sending a message, accessing an application, etc.) may be replaced with elements specific to the detected establishment. Such replacement may be graphical, in that access to the function is presented differently, or behavioral, in that the actual performance of the function is altered so it relates to the establishment in some manner, or even both. In this way, establishments may be able to automatically provide a site-controlled experience to the consumer-users.

The client-side application 360 may be deactivated based on various appropriate sets of criteria (e.g., by receiving a notification from the server-side application, 325 by determining that the user device 160 is outside a defined region, based on a command received from a user, etc.).

When the client-side application 360 is deactivated, the user device 160 may return to native mode.

One of ordinary skill in the art will recognize that system 300 is conceptual in nature and may be implemented in various specific ways without departing from the spirit of the invention. For instance, different embodiments may include different specific components and/or communication pathways among the various components.

### B. Communication Protocols

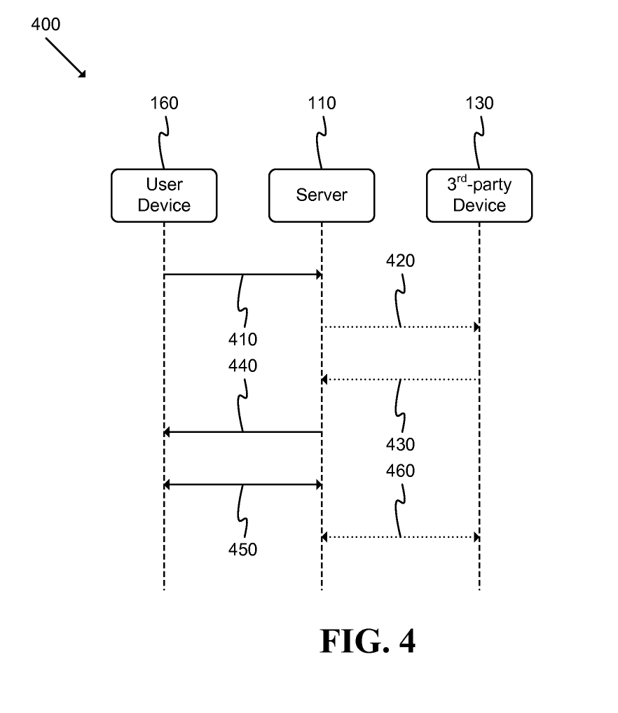

FIG. 4 illustrates a message flow diagram of a communication scheme 400 used by some embodiments of the systems of FIGS. 1-3 to provide an adaptive user experience. As shown, the communication scheme 400 may be implemented by at least one user device 160, at least one server 110, and/or other elements, which may include at least one 3^{rd} party device 130. In this example, one instantiation of each device type is shown. However, one of ordinary skill in the art will recognize that each device may communicate among multiple other devices, including multiple devices among each type.

As shown, the user device 160 may send a notification message 410 upon entering a defined region. Such a message may be sent based at least partly on a determined location of the user device. Such a determination may be made by the user device 160, server 110, and/or 3^{rd} party devices 130 in various appropriate ways. Alternatively, the notification message may be sent to the user device 160 by the server 110 and/or 3^{rd} party devices 130, when appropriate. Depending on the nature of the notification message, the adaptive experience may be initiated in various ways (e.g., by the user device itself based on a location determination, based on a message received from the server, based on a message received from a 3^{rd} party resource, etc.).

Next, the server 110 may interact with one or more 3^{rd} party devices 130 by sending and/or receiving a set of messages 420 and 430. Depending on the implementation, the server 110 may request and receive information related to the 3^{rd} party experience. Alternatively, the server may have previously received such information and may not need to interact with the 3^{rd} party devices 130.

Next, the server 110 may respond to the notification message 410 sent by the user device 160. The response message 440 may include data and/or instructions related to the defined region. Such communications may include an activation of the adaptive user experience from native mode.

After establishing a connection, the user device 160 and server 110 may continue to send communication messages 450, as appropriate. For instance, a user may enter a search query which may then be relayed to the server 110. The server may collect data in response to the query and send the results back to the user device 160. Likewise, the server 110 and 3^{rd} party devices 130 may continue to send communication messages 460, as appropriate. For instance, a 3^{rd} party user may upload new graphics or prices to the server 110 which may, in turn, send updated information to the user device 160.

One of ordinary skill in the art will recognize that the communication scheme 400 is conceptual in nature and may be implemented in various different ways without departing from the spirit of the invention. For instance, different specific messages than shown may be sent in various different orders than shown. In addition, each message may represent multiple sets of data sent among the various elements.

Although the system 300 and protocols 400 were described with reference to a distributed system such as system 100, one of ordinary skill in the art would recognize that similar software elements may be utilized in a local system such as system 200.

### III. Methods of Operation

Sub-section III.A provides a conceptual overview describing the operations used by some embodiments to provide an adaptive user experience. Sub-section III.B then describes integration of an establishment into the adaptive user experience. Next, sub-section III.C describes integration of third-party resources into the adaptive user experience. Sub-section III.D follows with a description of user device integration into the adaptive user experience. Lastly, sub-section III.E describes integration of analytic information into the adaptive user experience.

The various methods described below may be performed by systems such as system 100, system 200, system 300 described above, system 1200 described below in reference to FIG. 12, and/or other appropriate systems.

### A. Overview

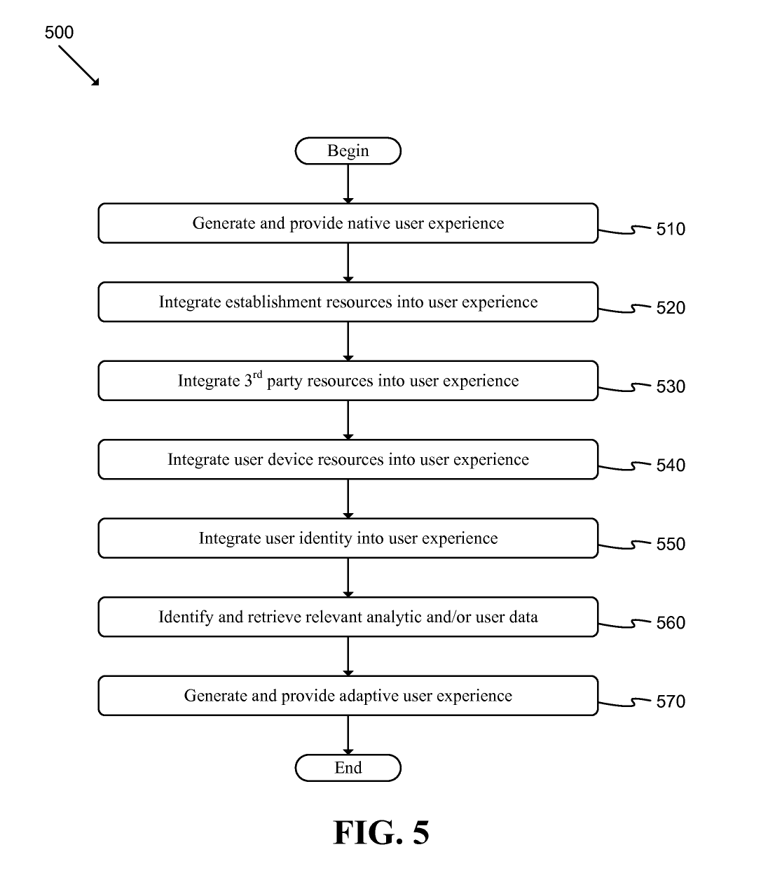

FIG. 5 illustrates a flow chart of a conceptual process 500 used by some embodiments to provide an adaptive user experience. Such a process may begin, for instance, when a user device is turned on or when an application of some embodiments is executed by the user device.

As shown, the process may generate and provide (at 510) a native user experience. Such a native experience may be defined by the device, operating system, user preferences, and/or other relevant factors. Such a native experience may be similar to the experience of a user when no adaptive user experience is available on the user device.

Next, the process may integrate (at 520) establishment resources into the adaptive user experience. Such integration will be described in more detail below in reference to process 600.

Process 500 may then integrate (at 530) 3^{rd} party resources into the adaptive user experience. Such integration will be described in more detail below in reference to processes 700-800.

Next, process 500 may integrate (at 540) user device resources into the adaptive user experience. The process may then integrate (at 550) user identity into the user experience. Such integration will be described in more detail below in reference to processes 900-1000.

Process 500 may then identify and retrieve (at 560) relevant analytic and/or user data. Such data may be utilized as described in more detail below in reference to process 1100.

Finally, process 500 may generate and provide (at 570) the adaptive user experience and then end. The adaptive user experience may be based at least partly on one or more of the resources integrated at 520-550. In addition, the relevant data identified at 560 may be used to at least partly influence or control features of the adaptive user experience.

### B. Establishment Integration

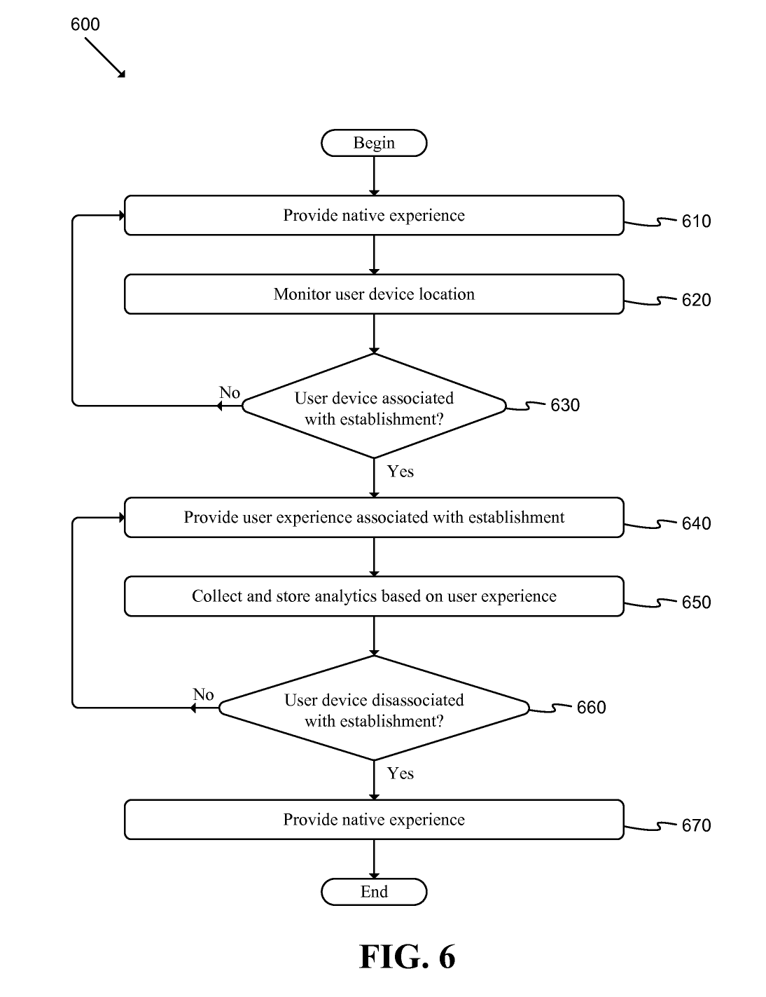

FIG. 6 illustrates a flow chart of a conceptual process 600 used by some embodiments to provide an adaptive user experience based on an association with an establishment Such a process may begin, for instance, when a user device is powered on. Such a process may be executed by a user device, server, 3^{rd} party devices, and/or a combination of those elements.

The process may provide (at 610) the native experience. Next, the process may monitor (at 620) the user device location (and/or other relevant factors). The process may then determine (at 630) whether the user device is associated with an establishment (e.g., by determining whether the device is within a defined region associated with the establishment). If the process determines (at 630) that the user device is not associated with an establishment, the process may continue to provide (at 610) the native experience and monitor (at 620) the user device location until the process determines (at 630) that the user device is associated with an establishment.

In some embodiments, user device location may be used to infer an intent from the location of the user device. For instance, if a user takes a similar route from home to a particular store, the user device may determine the user's intent to visit the store based on the user device location moving from home along the similar route, even if the destination has not been reached.

Alternatively and/or conjunctively to determining whether the user device is associated with an establishment by determining whether the user device is within a defined region, the process may evaluate other available data to determine when to launch an adaptive user experience. For instance, audio recognition may be used to detect environment based on audible conversations, background sounds or noise (e.g., when a user is watching a movie, television show, etc. that may be associated with an establishment), and/or other relevant factors.

If the process determines (at 630) that the user device is associated with the establishment, the process may provide (at 640) a user experience associated with the establishment. Next, the process may collect and store (650) analytics based at least partly on the user experience. Such analytics may include, for instance, search queries of the user, duration of time spent in a defined region (which may include time spent in sub-regions of a single establishment), purchase information, etc.

The analytic data may be provided to various 3^{rd} party users. For instance, average time spent in various sections of a retail or grocery store by multiple consumers may allow a store manager to allocate space in a more desirable manner. Such data may be able to be accessed via the dashboard of some embodiments. In some embodiments, the data may be collected anonymously (e.g., each data element may be associated with a unique device ID that is not able to be matched to a particular user by 3^{rd} parties).

Some embodiments may analyze the analytic data to adapt the user experience. For instance, search queries may be compared to purchases and used to at least partially control responses provided to future search queries.

The process may then determine (at 660) whether the user device has disassociated with the establishment (e.g., by moving outside the defined region). If the process determines (at 660) that the user device has not disassociated with the establishment, the process may continue to provide (at 640) the adaptive user experience and/or collect and store (at 650) analytics until the process determines (at 660) that the user device has disassociated with the establishment.

If the process determines (at 660) that the user device has disassociated with the establishment, the process may provide (at 670) the native experience and then end or, alternatively, resume monitoring (at 620) the user device location.

### C. Third-Party Integration

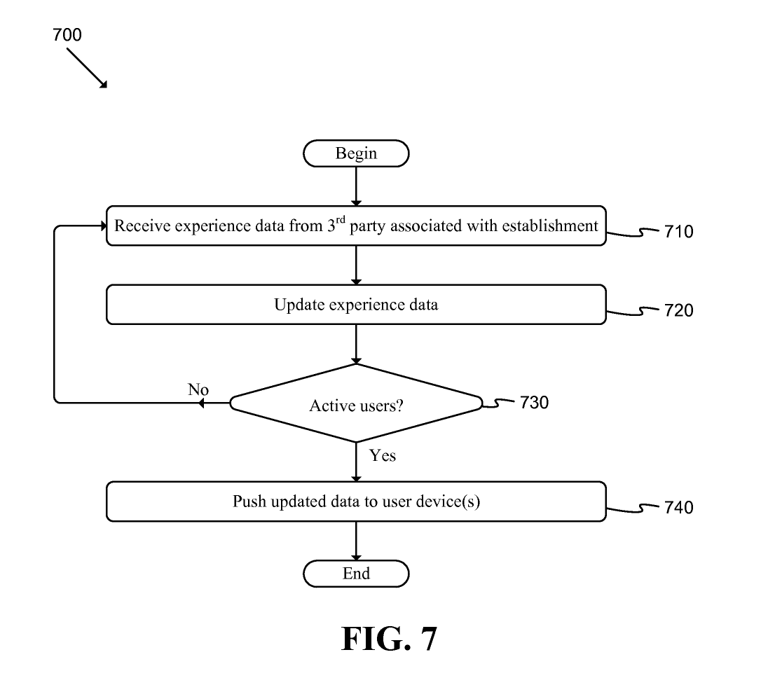

FIG. 7 illustrates a flow chart of a conceptual process 700 used by some embodiments to update data associated with the adaptive user experience. Such a process may begin, for instance, when a 3^{rd} party user accesses the dashboard of some embodiments. Such a process may be executed by the user device, server, 3^{rd} party devices, and/or a combination of those elements.

The process may receive (at 710) experience data associated with the establishment. Such experience data may be provided by a 3^{rd} party associated with establishment. Such data may be received via the dashboard of some embodiments. Alternatively, the 3^{rd} party may update data on a 3^{rd} party storage that is made available to the server and/or user device of some embodiments.

The experience data received from the 3^{rd} party may include data such as price information, product information, etc. In addition, the data may include UI data related to the presentation of various UI elements during the adaptive user experience. In this way, 3^{rd} party users may be able to design each screen presented to a user and dynamically update such data as provided to consumer-users. Such design may include placement and sizing of elements, graphic content, etc.

The process may then update (at 720) experience data. Such update may include updates to data stored by the server on various associated storages. Next, the process may determine (at 730) whether there are active users. If the process determines (at 730) that there are no active users, the process may continue to receive (at 710) and update (at 72) experience data until the process determines (at 730) that there are active users that have not received the latest updates, at which point the process may push (at 740) the updated data to the user devices associated with the active users and then may end. In this way, establishments may push content (e.g., marketing materials) to users in real time.

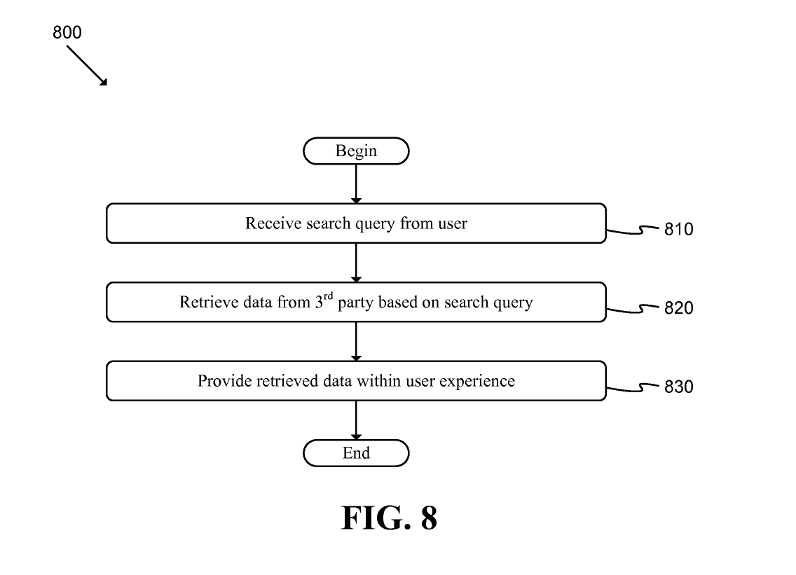

FIG. 8 illustrates a flow chart of a conceptual process 800 used by some embodiments to provide relevant information within the adaptive user experience based on a query Such a process may begin, for instance, when an adaptive user experience is presented to a consumer-user. Such a process may be executed by the user device, server, 3^{rd} party devices, and/or a combination of those elements.

As shown, the process may receive (at 810) a search query from the user. Next, the process may retrieve (at 820) data from a 3^{rd} party based on the search query. Alternatively, the data may be retrieved from a storage associated with the server of some embodiments. The process may then provide (at 830) the retrieved data within the user experience and then may end. In addition, in some embodiments, the process may retrieve data from an establishment system or storage. Such data may be selected based at least partly on the search query and/or the 3^{rd} party response to the query.

As one example, a consumer-user may search for an item such as toothpaste. The search query may result in a list of available brands, sizes, types, etc. of toothpaste. In addition, the list may include prices, store location for the different results, etc.

Some embodiments may tailor the search query (e.g., by formatting and/or modifying a user query before sending the query to the third party) in order to provide more relevant information to a user (e.g., by appending establishment information to the query). In addition, the query results may be tailored before being presented to a user such that the results may reflect the current location and/or other relevant factors associated with the user (e.g., identity, mood, intent, etc.).

### D. User Device Integration

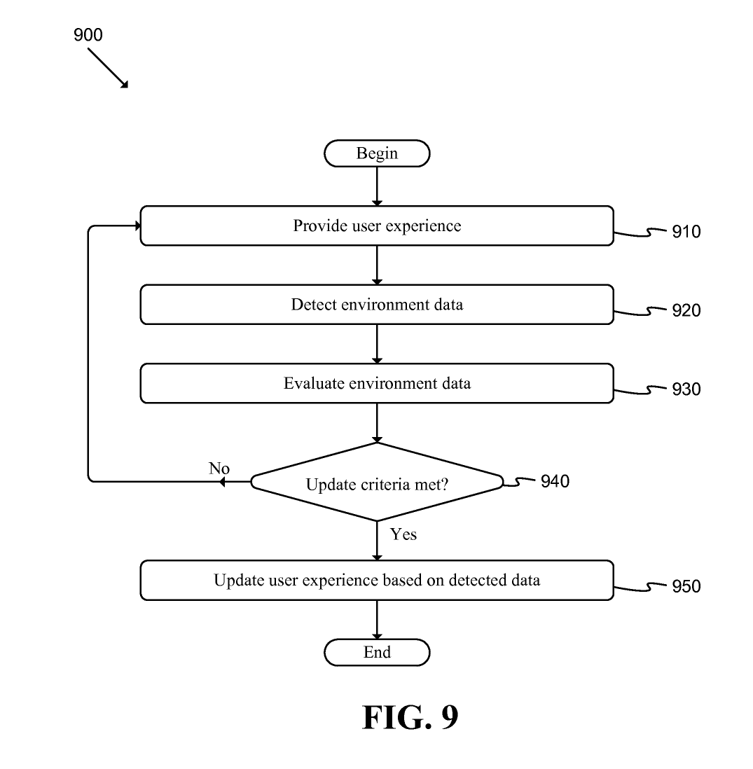

FIG. 9 illustrates a flow chart of a conceptual process 900 used by some embodiments to provide a real-time adaptive user experience using environmental elements associated with an establishment. Process 900 may be performed, for instance, as a sub-process of process 600 described above (e.g., at operation 640). Such a process may be executed by the user device, server, 3^{rd} party devices, and/or a combination of those elements.

As shown, the process may provide (at 910) the user experience. The provided experience may be a native experience or one of a set of available adaptive experiences, definitions for which may be embedded in the user device, included in a client-side application, or downloaded dynamically from a server-side application, using elements similar to those described above in reference to software system 300. Next, the process may detect (at 920) environment data and/or activity data. Such data may include, for instance, audio data (such as user speech recognize, background audio or noise, etc.), video data, etc., as described above in reference to system 200. In some embodiments, a camera, microphone, and/or other element included with the user device may allow image data to be captured, audio data to be recorded, etc.

The process may then evaluate (at 930) the environment data. Such evaluation may involve, for example, evaluating image data to determine an identity of the user (e.g., from among a set of registered users associated with the user device). In some embodiments, the evaluation may include analyzing a mood of the user (e.g., based on facial expression, audio data, etc.).

Next, the process may determine (at 940) whether any update criteria has been met. Such update criteria may include, for instance, a change in user identity (e.g., when a user device is passed from one spouse to another during a shopping experience), change in mood (e.g., when the facial expression or speech patterns of a user indicate boredom, excitement, etc.), and/or other appropriate criteria.

If the process determines (at 940) that no update criteria has been met, the process may continue to provide (at 910) the user experience, detect (at 940) environment data, evaluate (at 930) the data, and determine (at 940) whether some update criteria has been met until the process determines (at 940) that the update criteria has been met.

If the process determines (at 940) that some update criteria has been met, the process may update (at 950) the user experience based at least partly on the retrieved data and then may end. Such an update may include, for instance, updating the user experience based on a change in user such that items of interest to the new user are displayed, updating the experience based on a change in mood such that the graphical display elements may produce an improved mood, etc.

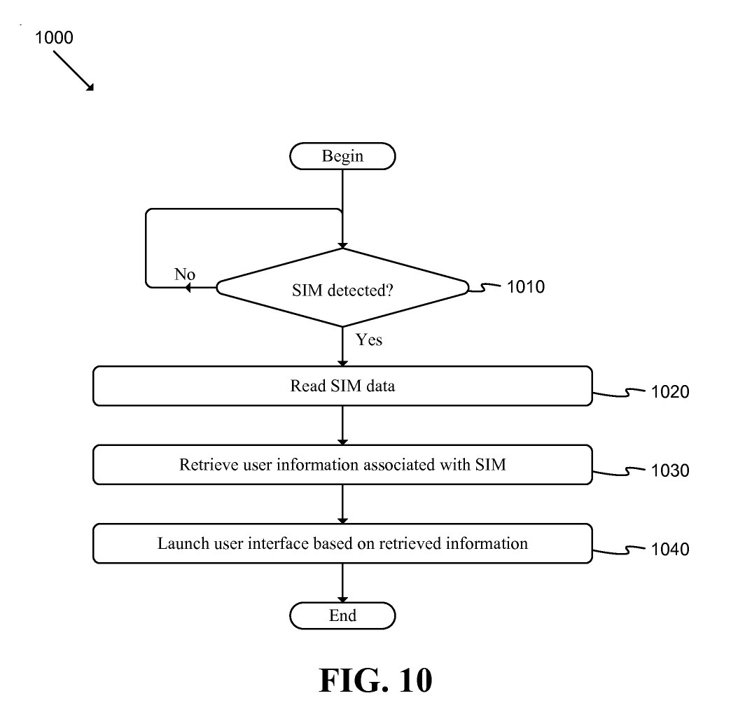

FIG. 10 illustrates a flow chart of a conceptual process 1000 used by some embodiments to update a user experience based on a subscriber identification module (SIM) or other removable identification element. Such a process may begin, for instance, when a user device is powered on. Such a process may be executed by the user device, server, 3^{rd} party devices, and/or a combination of those elements.

Process 1000 may then determine (at 1010) whether a SIM is detected (i.e., whether a SIM is connected to the user device). Such a determination may be made in various appropriate ways. For instance, a custom field may be included by a mobile virtual network operation (MVNO) or other service provider, an operator or user, and/or other appropriate ways. Alternatively and/or conjunctively, a mobile network code (MNC) associated with the SIM may be determined based on the integrated mobile device subscriber identity (IMSI) associated with the user device.

Next, the process may read (at 1020) the SIM data. The process may then retrieve (at 1030) user information associated with the SIM. Such user information may be retrieved locally from the user device and/or from a remote server, as appropriate.

The process may then launch (1040) a user interface based at least partly on the retrieved information associated with the SIM and then may end. If no information is associated with the SIM, a default user interface may be launched (or the default phone interface may continue to be used without change).

Although the example above has been described by reference to a SIM, one of ordinary skill in the art will recognize that various other devices capable of storing data may be used by such a process (e.g., a flash drive or any other media device capable of being read by the user device). Such a SIM or other appropriate device used as an identifying element may be implemented as a removable “card”, “stick” and/or other appropriate forms. The removable identifying element may include various circuitry such as one or more integrated circuits (ICs).

Some embodiments may iteratively perform processes 1000 and 900 and switch from a native experience to an adaptive experience based on the SIM detection, and update the adaptive experience based on the sensed environment elements.

### E. Adaptive Analytics

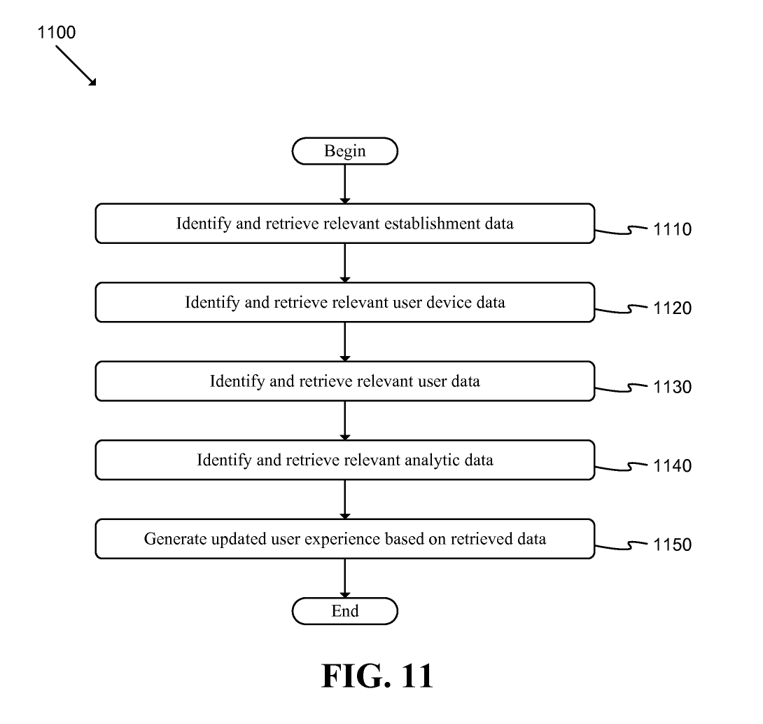

FIG. 11 illustrates a flow chart of a conceptual process 1100 used by some embodiments to update a user experience based on relevant analytic data. Such a process may be performed, for instance, as a sub-process of process 600 described above (e.g., at operation 640). Process 1100 may be executed by the user device, server, 3^{rd} party devices, and/or a combination of those elements.

As shown, the process may identify and retrieve (at 1110) relevant establishment data. Such data may include data related to an establishment, such as an association with a retail chain, product line, etc.

Next, the process may identify and retrieve (at 1120) relevant user device data. Such data may include data related to a user device, such as device type, brand, model, features, etc.

The process may then identify and retrieve (at 1130) relevant user data. Such data may include data related to a user, such as demographic data, user preferences, user shopping history, etc.

Next, the process may identify and retrieve (at 1140) relevant analytic data. Such data may include data that may be associated with similar users, user devices, establishments, and/or otherwise appropriate data that may be relevant to the user experience.

The process may then generate (at 1150) an updated user experience based at least partly on the retrieved data. The updated user experience may include updates to display elements (e.g., choosing graphical features that may be more attractive to a current user), updates to displayed data elements (e.g., lists of products may be updated based on analytic data associated with similar users and/or retailers), etc.

One of ordinary skill in the art will recognize that processes 500-1100 are conceptual in nature and may be performed in various different ways without departing from the spirit of the invention. For instance, different embodiments may include different additional operations, omit some operations described above, and/or perform the operations in various different orders. As another example, each process may be divided into a set of sub-processes or included as a sub-process of a macro-process. In addition, each process, or portions thereof, may be performed iteratively (e.g., continuously, at regular intervals, based on some criteria, etc.).

### IV. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, Digital Signal Processors (DSPs), Application-Specific ICs (ASICs), Field Programmable Gate Arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be adapted to perform functions and/or features that may be associated with various software elements described throughout.

FIG. 12 illustrates a schematic block diagram of a conceptual computer system 1200 used to implement some embodiments of the invention. For example, the system described above in reference to FIGS. 1 and 3 may be at least partially implemented using computer system 1200. As another example, the processes described in reference to FIGS. 5-11 may be at least partially implemented using sets of instructions that are executed using computer system 1200.

Computer system 1200 may be implemented using various appropriate devices. For instance, the computer system may be implemented using one or more personal computers (“PC”), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 1200 may include at least one communication bus 1205, one or more processors 1210, a system memory 1215, a read-only memory (ROM) 1220, permanent storage devices 1225, input devices 1230, output devices 1235, various other components 1240 (e.g., a graphics processing unit), and one or more network interfaces 1245.

Bus 1205 represents all communication pathways among the elements of computer system 1200. Such pathways may include wired, wireless, optical, and/or other appropriate communication pathways. For example, input devices 1230 and/or output devices 1235 may be coupled to the system 1200 using a wireless connection protocol or system.

The processor 1210 may, in order to execute the processes of some embodiments, retrieve instructions to execute and/or data to process from components such as system memory 1215, ROM 1220, and permanent storage device 1225. Such instructions and data may be passed over bus 1205.

System memory 1215 may be a volatile read-and-write memory, such as a random access memory (RAM). The system memory may store some of the instructions and data that the processor uses at runtime. The sets of instructions and/or data used to implement some embodiments may be stored in the system memory 1215, the permanent storage device 1225, and/or the read-only memory 1220. ROM 1220 may store static data and instructions that may be used by processor 1210 and/or other elements of the computer system.

Permanent storage device 1225 may be a read-and-write memory device. The permanent storage device may be a non-volatile memory unit that stores instructions and data even when computer system 1200 is off or unpowered. Computer system 1200 may use a removable storage device and/or a remote storage device 1260 as the permanent storage device.

Input devices 1230 may enable a user to communicate information to the computer system and/or manipulate various operations of the system. The input devices may include keyboards, cursor control devices, audio input devices and/or video input devices. Output devices 1235 may include printers, displays, and/or audio devices. Some or all of the input and/or output devices may be wirelessly or optically connected to the computer system.

Other components 1240 may perform various other functions. These functions may include performing specific functions (e.g., graphics processing, sound processing, etc.), providing storage, interfacing with external systems or components, etc.

Finally, as shown in FIG. 12, computer system 1200 may be coupled to one or more networks 1250 through one or more network interfaces 1245. For example, computer system 1200 may be coupled to a web server on the Internet such that a web browser executing on computer system 1200 may interact with the web server as a user interacts with an interface that operates in the web browser. Computer system 1200 may be able to access one or more remote storages 1260 and one or more external components 1265 through the network interface 1245 and network 1250. The network interface(s) 1245 may include one or more application programming interfaces (APIs) that may allow the computer system 1200 to access remote systems and/or storages and also may allow remote systems and/or storages to access computer system 1200 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1200 may be used in conjunction with the invention. Moreover, one of ordinary skill in the art will appreciate that many other system configurations may also be used in conjunction with the invention or components of the invention.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments of the invention and modifications may be made without departing from the spirit and scope of the invention as defined by the following claims.

We claim:

1. An automated method adapted to provide an adaptive user experience, the method comprising:
determining that a user device is within a defined region;
receiving a set of user experience elements associated with the defined region;
generating an adaptive user interface (UI) that includes at least a sub-set of the user experience elements; and
providing the adaptive UI via at least one output element of the user device.

2. The automated method of claim 1 further comprising:
determining that the user device is no longer within the defined region; and
generating and providing a native UI via the user device.

3. The automated method of claim 1 further comprising collecting analytic information related to the adaptive user experience.

4. An automated method adapted to provide an adaptive user experience via a user device, the method comprising:
determining whether a subscriber interface module (SIM) is connected to the user device;
reading data from the SIM;
retrieving user information associated with the SIM; and
presenting a user interface based at least partly on the retrieved user information.

5. A user device comprising:
a communications module adapted to communicate with external devices using at least one wireless communication pathway;
a set of software interfaces adapted to allow interaction with a set of software components of the user device;
a set of hardware interfaces adapted to allow interaction with a set of hardware elements of the user device; and
a set of user interface (UI) modules adapted to generate UI elements to be presented via at least one hardware element from the set of hardware elements.

6. The user device of claim 5, wherein:
the set of software interfaces and the set of hardware interfaces are adapted to determine a user device location, and
the set of UI modules is able to generate and present:
an adaptive user experience when the user device location is within a defined region, and
a native user experience when the user device location is outside the defined region.

7. The user device of claim 5, wherein:
the set of software interfaces and the set of hardware interfaces are adapted to detect a set of environmental elements based at least partly on data provided by a set of sensor elements of the user device, and
the set of UI modules is able to generate and present an adaptive user experience based at least partly on the detected set of environment elements.

8. The user device of claim 7, wherein the set of sensor elements comprises a microphone and the user device further comprises an audio analysis processor adapted to receive and process audio information via the microphone.

9. The user device of claim 8, wherein the audio analysis processor is configured to detect user activity and location based at least partly on audible conversations and background sounds received via the microphone.

10. The user device of claim 7, wherein the set of sensor elements comprises a camera and the user device further comprises a video analysis processor adapted to receive and process video information received via the camera.

11. The user device of claim 10, wherein the video analysis processor is configured to detect user mood based at least partly on facial expressions received via the camera.

12. The user device of claim 10, wherein the video analysis processor is configured to detect user activity and location based at least partly on visible surroundings received via the camera.

13. The user device of claim 7, wherein the set of sensor elements comprises a global positioning system (GPS) receiver and the user device further comprises a geolocation analysis processor adapted to receive and process GPS data received via the GPS receiver.

14. The user device of claim 13, wherein the geolocation analysis processor is configured to detect user activity and intent based at least partly on data received via the GPS receiver.

15. The user device of claim 7, wherein:
the set of sensor elements comprises a microphone, a camera, and a global positioning system (GPS) receiver, and
the user device further comprises:
an audio analysis processor adapted to receive and process audio information via the microphone;
a video analysis processor adapted to receive and process video information received via the camera; and
a geolocation analysis processor adapted to receive and process GPS data received via the GPS receiver,
wherein the audio analysis processor, video analysis processor, and geolocation analysis processor are configured to cooperatively detect user location, activity, intent, and mood based at least partly on data received via at least one of the microphone, camera, and GPS receiver.

16. The user device of claim 15, wherein at least one of the detected user location, activity, intent, and mood is associated with an establishment and the adaptive user experience is based at least partly on the establishment.

17. The user device of claim 16, wherein the establishment-based adaptive user experience includes resources for providing a tailored search query via a third-party resource.

18. The user device of claim 16, wherein the establishment-based adaptive user experience provides at least one of access, assistance, entertainment, and incentives related to the establishment.

19. The user device of claim 5, wherein:
the set of software interfaces and the set of hardware interfaces are adapted to detect a subscriber interface module (SIM), and the set of UI modules is able to generate and present:
an adaptive user experience when the SIM is detected, and
a native user experience when the SIM is not detected.

20. The user device of claim 19, wherein:
the set of software interfaces and the set of hardware interfaces are adapted to detect a set of environmental elements based at least partly on data provided by a set of sensor elements of the user device, and
the set of UI modules is able to generate and present an updated adaptive user experience based at least partly on the detected set of environment elements.

21. A system adapted to generate and provide an adaptive user experience, the system comprising:
a server comprising:
a storage interface;
a dashboard;
a control module;
a communications module; and
a server-side application;
a user device comprising:
a client-side application;
a communications module;
a set of software interfaces;
a set of hardware interfaces; and
a user interface (UI) module; and
a third party device comprising:
a browser;
a storage interface; and
a third-party application.

22. The system of claim 21, wherein:
the set of software interfaces and the set of hardware interfaces are adapted to determine a user device location, and
the UI module is able to generate and present:
an adaptive user experience when the user device location is within a defined region, and
a native user experience when the user device location is outside the defined region.

23. The system of claim 21, wherein the user device further comprises:
a set of sensor elements including a microphone, a camera, and a global positioning system (GPS) receiver, and
an audio analysis processor adapted to receive and process audio information via the microphone;
a video analysis processor adapted to receive and process video information received via the camera; and
a geolocation analysis processor adapted to receive and process GPS data received via the GPS receiver,
wherein the audio analysis processor, video analysis processor, and geolocation analysis processor are configured to cooperatively detect user location, activity, intent, and mood based at least partly on data received via at least one of the microphone, camera, and GPS receiver.

24. An automated method adapted to provide an adaptive user experience, the method comprising:
providing a first user experience;
detecting and identifying a set of environmental elements;
determining whether some update criteria have been met based at least partly on the set of environmental elements; and
generating and providing a second user experience when the update criteria have been met and providing the first user experience when the update criteria have not been met.
